(19) United States
(12) Patent Application Publication
(10) Pub. No.: US 2008/0162351 A1
(43) Pub. Date: Jul. 3, 2008

(54) CHECK CONVERSION PLUS

(76) Inventors: Timothy S. LaBadie, Novato, CA (US); Paul H. Green, Petaluma, CA (US); J. D. Siembieda, Petaluma, CA (US); Gayle M. Pena, Rohnert Park, CA (US)

Correspondence Address: QUARLES & BRADY LLP, 411 E. WISCONSIN AVENUE, SUITE 2040, MILWAUKEE, WI, 53202-4497, US

(21) Appl. No.: 12/046,973

(22) Filed: Mar. 12, 2008

Related U.S. Application Data
(63) Continuation of application No. 10/090,360, filed on Mar. 4, 2002, now abandoned.
Application No. 10/090,360 is a continuation-in-part of application No. 09/259,619, filed on Mar. 1, 1999, now Pat. No. 7,356,502.
(60) Provisional application No. 60/273,924, filed on Mar. 7, 2001.

(51) Int. Cl. G06Q 20/00

(52) U.S. Cl. 705/45

(57) ABSTRACT

A system for merchants to electronically process statistically-analyzed checks and receive payment on the same electronically from a third-party service provider while the image of the check writer's check is stored electronically and the payment itself is presented through the normal check-processing system.

### CROSS-REFERENCE TO RELATED APPLICATIONS

This application is a continuation of U.S. patent application Ser. No. 10/090,360, filed Mar. 4, 2002, which claims the benefit of U.S. provisional application 60/273,924, filed Mar. 7, 2001 and hereby incorporated by reference. This application is further a continuation-in-part of co-pending U.S. provisional application 60/076,655 filed Mar. 3, 1998, now U.S. utility application 09/259,619, filed Mar. 1, 1999, all hereby incorporated by reference in their entirety.

### STATEMENT REGARDING FEDERALLY SPONSORED RESEARCH OR DEVELOPMENT

### BACKGROUND OF THE INVENTION

It is widely expected that the physical processing of paper checks will eventually be replaced by electronic processing techniques. While the possibility of a “checkless society” is years, perhaps decades away, it is imperative that the groundwork for the replacement of the paper check happens now.

At the current time there are various electronic check products in the marketplace that move toward this “checkless society.” These supposed solutions come under various different names, from check truncation, to electronic check conversion, to electronic check presentment. Each of these products uses an electronic device to begin the process. After the check writer hands the check to the merchant, the merchant scans it through a device and hands the check back to the check writer. With these products, both the debiting of the check writer's checking account and the crediting of the merchant's checking account are done electronically through the Automatic Clearing House (ACH) system. Through this electronic processing mechanism the check “float” that has historically been an important part of the check writer's benefit when writing checks is eliminated. On the surface, these products have significant benefits for their merchant users, from decreased processing time of paper checks to possible reduction of the cost of processing these items. Unfortunately in reality each of these products have significant, substantial deficiencies and create problems for both the check writer who writes the converted check and the merchant who uses these products.

The widespread problems that these supposed solutions have created involve two primary areas: first is the rampant administrative errors of converted checks when processed through ACH, and the second is the loss of check writer contact information following the conversion of the check at the point of sale. Administrative errors on these systems are frequent and significant. These administrative errors are due to the fact that the Magnetic Ink Character Recognition (MICR) line on checks was only intended to get a check to its proper clearing location, but it was never designed to complete the payment to the Demand Deposit Account (DDA) of the check writer. Current electronic processing systems must rely on regional MICR data and infrequent congestion to pass items through the ACH system. Misreads of the MICR line by the equipment used by these products significantly adds to the level of errors. These administrative errors can result in a good check, drawn upon a valid bank account, with sufficient funds in the account to cover the processed check, being returned unpaid because the check was unable to be presented to the check writer's account for payment. Further, with the loss of contact information, the merchant has no way to contact the check writer to advise them that their check was returned and is unable to recover the funds from the check writer because of the lack of contact information.

What is needed is the creation of a system that implements all the benefits of these electronic solutions to maximize the efficiency and cost reduction without the administrative errors and loss of contact information inherent with these products.

### BRIEF SUMMARY OF THE INVENTION

The present invention provides an electronic check-processing system for the merchant to use when accepting a check from a check writer. This system eliminates the need for MICR scrubbing and eliminates equipment misreads. Through this invention, the merchant will process the check electronically through a service provider, receive a recommendation from the service provider to accept or decline the check based on a statistical analysis about the probability of the payment being honored, receive payment electronically from the service provider for processed checks, and have their account kept whole while the check is processed by the service provider. If the processed check is later returned and the merchant is a “verification only” customer, the merchant's account may be debited for the amount of the subject check. If the merchant is a “guarantee” customer the merchant's account is kept whole, provided terms and conditions of a contract are met. Further, the present invention provides for the capture and storage of the image of the check writer's check and the processing of the payment of the check through the traditional check payment system.

Under the program envisioned here, a merchant's store will be equipped with a check-image scanner, a predefined Personal Data Assistant (PDA) check-image system, or another image transfer device connected to a communication device programmed to contact a service provider. The merchant, upon accepting a negotiated check from a check writer, would use the check image scanner to scan the check writer's check and enter the amount of the subject check. The communication device will contact the service provider and that service provider will check at least one statistical element to indicate the probability that the check will be honored by the check writer's bank. The statistical element may include information about the check writer (such as payment history), or about the transaction (such as the type and price of goods), or about the check writer's data supplied by the merchant (such as the legitimacy of driver's license or check numbers). Based on this probability, the service provider will then return a message to the communication device recommending to the merchant to either accept or decline the check. If the service provider recommends the check not be accepted the merchant may still process the check using the technology of this invention. If the check is processed through the technology envisioned in this invention, either a receipt may be printed on the merchant's system with language for the check writer to read and understand regarding the transaction or the appropriate information will be stamped on the check. If applicable, the merchant will give the receipt to the check writer and ask them to sign the same. The merchant will then retain one copy of the receipt and give the other copy to the check writer to keep.

The check-image transfer device captures the image of the check, and while the service provider is conducting the above probability review, the image of the check, along with the image of the check writer's receipt, is transmitted to an image repository for image storage.

For checks that are recommended to be accepted by the service provider, or those checks for “guarantee” customers that are recommended to be declined but the merchant desires to proceed without a guarantee, the converted check is assigned to the service provider at the point of sale. At the time of assignment, the following transaction information about the subject check is transmitted to the service provider: the Magnetic Ink Character Recognition numbers-including routing/ transit number, account number, and check number; and the amount of the check.

The above transaction information for checks processed through this invention is then transferred to a check-printing software program and is used to create a sight draft, which may or may not include a delay in posting the sight draft based on an arrangement with the merchant to delay posting. The image of the scanned check may be printed on the sight draft. This draft is then deposited in the bank account of the service provider and the draft is presented for payment to the check writer's account through the traditional banking system. The service provider then processes an electronic transfer, via ACH, to the merchant's bank account equal to the amount of the assigned check. The system may or may not include risk-management criteria that can include the netting of fees and/or the hold-back of funds for risk-management purposes. If the merchant is a “verification only” customer and the sight draft is returned unpaid, the merchant's account is debited, via ACH, for the amount of the returned draft. If the merchant is a “guarantee” customer, the merchant's account is kept whole provided the merchant adhered to the terms and conditions of the service provider's contract relative to the subject check. If the merchant does not adhere to the terms and conditions of this contract relative to the subject check, then the merchant's account may be debited for the amount of said check.

### DETAILED DESCRIPTION OF THE PREFERRED EMBODIMENT

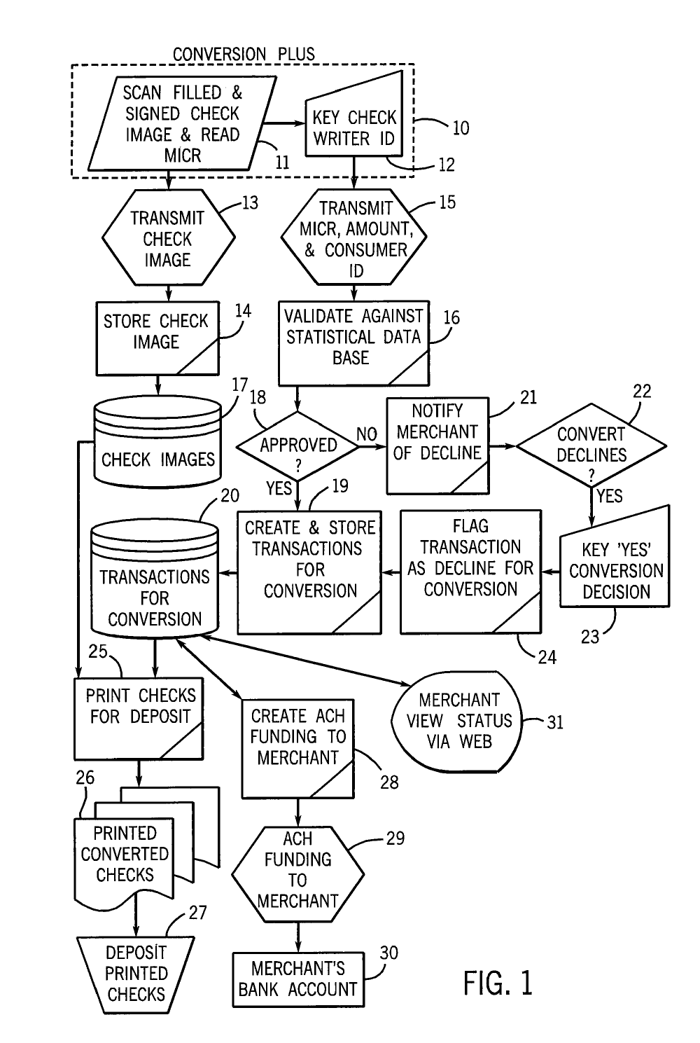

Referring to FIG. 1, a check writer provides payment for a purchase of goods or services from a merchant by handing the merchant a completely filled out, signed check or a secure check image originating from a PDA and including a real-time facsimile of the physical signature.

Using a (10) communication system comprised of a Check Scanner, or another image transfer device, (11) and a Key Input Device (12), either separate devices or integrated devices, capable of communicating independently or serially, either via traditional telephone initiates the finalization wire or wireless, or another communication medium, the merchant of the purchase by scanning the check through the Check Scanner or other Image Transfer Device (11) and keying Check Writer Statistical Data into the Key Input device (12) and initiating a transmission of the Check Image(13) to the Service Provider for Check Image Storage (14) on an Electronic Mass Storage Device(17) and the Check Writer Statistical Data(15) to the Service Provider for Statistical Validation(16).

The Service Provider may or may not check at least one statistical element (16) to indicate the probability that the check will be honored by the check writer's bank (18). Generally, the statistical element may include information about the check writer (such as payment history), or about the transaction (such as the type and price of goods), or about the check writer's data supplied by the merchant (such as the legitimacy of driver's license or check number) such as to indicate the likelihood of a payment obligation being honored. The statistical information may include information about the check writer and the transaction including information such as the validity of MICR numbers, driver's license number, state of issuance, area code and phone number, and historical transaction data including occurrences of dishonored checks by that check writer, the amount of the purchase, the standard industrial classification of the merchant, and the number of purchases within a particular date range. Based on this probability, if the check is Approved under a Guarantee Service or Recommended under a Verification Service, the Service Provider will create and store (19) a transaction containing the statistical data, the minimum of which will be: Date, Check Number, MICR Number (Check Amount, Bank Routing number, Check Writer Bank Account Number) on a Device (20); if the check is Declined under a Guarantee Service or Not Recommended under a Verification Service, the Service Provider will notify the merchant of the Decline or Not Recommended(21).

The merchant, pursuant to the contract terms and conditions, can decide to finalize the purchase by accepting the Declined or Not Recommended check and converting (22) it by keying the decline override into the Key Input Device (23) and thus notifying the Service Provider of the decision.

The Service Provider will create and store (19) a decline override (24) transaction containing the statistical data, the minimum of which will be: Date, Check Number, MICR Number (Check Amount, Bank Routing Number, Check Writer Bank Account Number) on an Electronic Mass Media Device (20).

With the stored transaction's (20) statistical data and perhaps the related Check Images (17), the Service Provider will, depending on prearranged posting agreements with the merchant, print (25) sight drafts (26) payable to either the service provider or the merchant and deposit (27) the sight drafts (26) for normal industry processing.

Also for the stored transactions (20), the Service Provider will create an ACH transaction (28) to the merchant and transmit electronically (29) that transaction to the merchant's bank account (30) thus completing the payment settlement to the merchant.

Using a merchant computer (31), such as a PC style computer, a Web Computer, a wireless web device, a PDA, or another device providing a terminal and viewer including means for connecting to the Internet, a merchant may view all of their transactions (20) and related status for a specified span of time. If the merchant has contracted to have the ability to select which transactions (20)are to be printed (25) and funded (28), the merchant uses the merchant computer (31) to make that selection.

I/We claim:

1. A computerized method for merchants to accept authorized checks and receive payment on the same electronically from a third-party service provider comprising the following steps:
scanning a check from a check writer at a merchant location to acquire a check image;
transmitting the image of the check to a third party service provider, wherein the third party service provider processes the check using the following steps:
retrieving statistical data related to the check writer from the check image;
validating the statistical data against a database of check writer data to determine a probability that the check will be honored;
notifying the merchant that the check is declined when the probability is low, and providing the merchant with an option to override the decline and accept the check;
storing the check image in an image repository;
printing a sight draft of the check; and
depositing the image of the check in a bank account for processing.

2. The method of claim 1 further comprising the step of making the sight draft payable to the third party service provider.

3. The method of claim 1 further comprising the step of making the sight draft as payable to the third party service provider.

4. The method of claim 1, wherein the sight draft is processed through traditional check processing means.
